(19) United States
(12) Patent Application Publication
(10) Pub. No.: US 2013/0162215 A1
(43) Pub. Date: Jun. 27, 2013

(54) METHOD AND SYSTEM FOR MANAGING AN ELECTRICAL LOAD OF A USER FACILITY BASED ON LOCALLY MEASURED CONDITIONS OF AN ELECTRICITY SUPPLY GRID

(71) Applicant: Timothy Patrick Cooper, Dublin (IE)

(72) Inventor: Timothy Patrick Cooper, Dublin (IE)

(21) Appl. No.: 13/639,722

(22) PCT Filed: Apr. 7, 2011
(86) PCT No.: PCT/EP11/55455

§ 371 Date: Feb. 19, 2013

(30) Foreign Application Priority Data
Apr. 7, 2010 (GB) 1005801.4

(51) Int. Cl. H02J 4/00; H05B 3/00; H02J 7/00

(52) U.S. Cl. CPC H02J 4/00; H02J 7/0052; H02J 7/0063; H05B 3/00
USPC 320/127; 307/25; 320/137; 219/201

(57) ABSTRACT

The present invention relates to a method of managing the consumption and distribution of electricity in a user facility, wherein the user facility is connected to an electricity supply grid and the user facility comprises a grid connected on site generator; the method comprising the steps of measuring waveform conditions on a portion of the electricity supply grid adjacent the user facility to obtain locally measured waveform conditions; measuring electrical power readings from the on site generator; communicating the locally measured waveform conditions and the electrical power readings to a controller in the user facility; determining, at least on the basis of the locally measured waveform conditions, whether the electricity supply grid is oversupplied or undersupplied with electricity; and, modifying the flow of the electricity within the user facility based on whether the electricity supply grid is oversupplied or undersupplied with electricity and/or the electrical power readings from the grid connected on site generator.

### INTRODUCTION

This invention relates to a method of managing the import and export of electrical energy between a terminal user facility comprising a grid connected on site generator and an electricity supply grid.

The invention further relates to an electricity management system located in a terminal user facility for adjusting the electrical load of the user facility in response to the conditions on an electricity supply grid and the supply of electricity from grid connected on site generators.

There is a growing adoption in the use of smart meters as part of electricity supply systems throughout the World. A smart meter is a meter which can record the consumption of electrical energy in a facility, and, communicate with a centralised controller in the electricity supply system, otherwise referred to as the grid throughout this specification, to relay information regarding the time at which the electricity was consumed by the facility to facilitate multi-tariff pricing by the electricity network supplier, the quality of the supplied electricity, the occurrence of any blackouts and other such quality measurements and operational reporting.

It is widely acknowledged that the use of smart meters is integral to future electricity supply networks, and indeed other commodity distribution networks such as gas supply networks, water supply networks and communications supply networks where it is believed that multi-tariff pricing may be introduced to provide users with access to communications networks, such as the Internet, or cellular data networks, at different prices per data amount, e.g. per gigabyte, dependent on the time of use of the communications network. It will therefore be understood that the application of many of the principles which are described hereinbelow in relation to an electricity supply network may be equally well applied, mutatis mutandis, to any of the above mentioned supply networks.

With the wide adoption of this imminent technology, smart meters are already found in many domestic buildings and commercial buildings around the World. Indeed a number of countries throughout Europe and North America and Asia have publicly declared it their intentions to encourage the installation of smart meters throughout their jurisdictions within the next 10 to 15 years.

In addition to the presence of these smart meters in the user facilities, some of these terminal user facilities also comprise energy storage units, such as a thermal storage unit or a battery bank to receive and store electrical energy for use at a later time. This is particularly useful in multi-tariff electricity supply grids where relatively inexpensive electrical power may be imported from the grid during off-peak periods, and stored as energy for use during peak periods where relatively high tariffs apply. Alternatively, the stored energy may be exported back onto the grid if the electricity supply grid is undersupplied and the price for exportation of the electricity back onto the electricity supply grid is attractive and/or profitable to the owner's of the user facility.

Moreover, many user facilities, including households and commercial buildings alike, have begun to incorporate grid connected on site generators to supply some or all of their electricity requirements. These grid connected on site generators can be beneficial in reducing or in some cases entirely eliminating the cost of importing electricity from the electricity supply grid. In further scenarios, the operators of the grid connected on site generators may be able to export electricity to the electricity supply grid resulting in a financial gain. Additionally, excess electrical power which is not immediately required by a local user facility and which has been generated by a grid connected on site generator, referred to as on site generators or micro generators such as a solar panel or a wind turbine, located on the local user facility, may also be stored in the energy storage unit for subsequent use and/or be exported onto the electricity supply grid.

In order to effectively coordinate the importation and or exportation of electricity to and from the electricity supply grid, it is important that these smart meters have real time knowledge of the conditions of the electricity supply grid and of the electrical requirements of the user facility along with the estimated electrical output of any on-site generators which supply electricity to the user facility being controlled by the particular smart meter.

Currently, it is known for grid connected on site generator controller systems to receive measured conditions such as the voltage level, current strength, frequency, rate of change of voltage, rate of change of current, rate of change of frequency and other such characteristics of the electricity supply grid to determine if the electricity supply grid is oversupplied or undersupplied with electrical power.

A centralised controller in the electricity supply grid, which controls the flow of electrical power on the electricity supply grid, receives the measurements from instruments located at transformer stations, sub-stations, switching compounds and/or specific measuring points throughout the electricity supply grid. A determination is then made by the centralised controller in the electricity supply grid as to whether the electricity supply grid is oversupplied, and hence needs to export more electrical power, or, is undersupplied, and hence needs to import electrical power from the energy storage units in the user facilities.

Once this determination has been made, the centralised controller in the electricity supply grid communicates with a the grid connected on site generator controller systems located in the various terminal user facilities which are connected to the electricity supply grid. The grid connected on site generator controller systems carry out the instructions of the centralised controller to either import to or export from the electricity supply grid.

The problem with current systems is that a large number of communication packets need to be sent between the centralised controller and the grid connected on site generator controller systems, which may advantageously form part of the aforementioned smart meters, in order for the centralised controller to instruct all of the grid connected on site generator controller systems to either import to or export from the electricity supply grid in a synchronised and organised fashion so as to have the desired effect on the electricity supply grid.

As one could imagine, the coordination and organisation of such a large number of communications throughout an extended and distributed network is very troublesome and requires complex communications protocols with additional hardware to transmit, carry and receive the communications. It will be readily understood that as the distance from the centralised controller to the grid connected on site generator controller systems and/or smart meters increases, the effectiveness of the communications tends to decrease as the relevance of the information received by the controllers/smart meters diminishes due to the time lapse between the information being measured at a particular substation adjacent a user facility, the transmission of the measurements from the particular substation to the centralised controller, the processing of the information by the centralised controller and the subsequent transmission of the instructions to the controller/smart meter in the user facility adjacent the particular substation to either increase or decrease the load of the user facility in order to import or export electricity from the electricity supply grid.

Large, complicated centralised controllers are required in order to receive all of the measurement signals from the electricity supply grid, analyse these measurements and transmit appropriate control signals to each of the local control units within a short time period, which is of the order of approximately 5 seconds, so that the centralised controller can react in an effective manner to the current conditions of the grid.

A number of solutions have been proposed to overcome the difficulties highlighted hereinbefore.

PCT Patent Publication Number PCT/EP2004/010639 discloses an apparatus which is used to alter the load of an electrical appliance within an electrical network in a household, in response, for example, to the deviation from the ideal frequency of the mains electricity supply, which is being used to supply the electrical appliance. The responsive load apparatus which is described in PCT Patent Publication Number PCT/EP2004/010639 is connected to an electric load and the apparatus receives an input (in the form of the deviation from the ideal frequency) which is indicative of the demand on the mains power supply. As can be seen from PCT Patent Publication Number PCT/EP2004/010639, a small device is described which is meant to be connected to each appliance within a user facility separately. The device measures the input of the frequency of the mains supply electricity to the appliance to determine if the load established by that particular appliance should be increased or decreased to provide the most optimal electrical load for the conditions of the mains power supply.

There are a number of problems associated with the device described in PCT Patent Publication Number PCT/EP2004/010639. An extremely large number of devices would be needed throughout an entire user facility in order to provide an adaptive load which is altered in response to the mains power supply. PCT Patent Publication Number PCT/EP2004/010639 does not consider how these devices would communicate with one another and the devices do not measure the actual conditions of the grid itself, rather they measure the mains power supply within the user facility which is supplied to the electrical appliance. Thus, PCT Patent Publication Number PCT/EP2004/010639 is concerned with responsive load apparatuses which can be retro-fitted to existing electrical appliances such as freezers, fridges and the like, or can form part of newly designed electrical devices.

U.S. Pat. No. 3,906,242 discloses the use of thermal storage devices to increase or decrease the load on an electricity supply grid. U.S. Pat. No. 3,906,242 describes use of a centralised controller unit to coordinate the increase or decrease of the load and adjust the load to follow the conditions of the electricity supply grid. As mentioned hereinbefore, the use of a centralised controller is burdensome as the centralised nature of the controller requires a large communications network to be established throughout the entire electricity supply grid which results in complex communications protocols being adopted which in turn need expensive hardware and software solutions in order to operate efficiently.

It is a goal of the present invention to provide an apparatus that overcomes at least one of the above mentioned problems.

### SUMMARY OF THE INVENTION

The present invention relates to a method of managing the consumption and distribution of electricity in a user facility, wherein the user facility is connected to an electricity supply grid and the user facility comprises a grid connected on site generator; the method comprising the steps of measuring waveform conditions on a portion of the electricity supply grid adjacent the user facility to obtain locally measured waveform conditions; measuring electrical power readings from the on site generator; communicating the locally measured waveform conditions and the electrical power readings to a controller in the user facility; determining, at least on the basis of the locally measured waveform conditions, whether the electricity supply grid is oversupplied or undersupplied with electricity; and, modifying the flow of the electricity within the user facility based on whether the electricity supply grid is oversupplied or undersupplied with electricity and/or the electrical power readings from the grid connected on site generator.

The advantage of the present invention is that the measurement from the section of the grid which is adjacent the user terminal may be taken into account by the controller within the user terminal without extensive communication protocols and/or expensive communication hardware requirements. Moreover, due to the close geographical location of the controller to the locally-based measurement devices which provide the locally measured waveform conditions, the controller will be made aware of the waveform conditions in relative real-time as there will be very little time lag for the information to be sent from the locally-based measurements devices to the controller. This results in a more responsive system which can adapt to the variations and fluctuations on the electricity supply grid in a more instantaneous manner than any of the prior art systems and methods which continue to rely on a centralised controller approach.

The present invention is advantageous over PCT Patent Publication Number PCT/EP2004/010639 as PCT Patent Publication Number PCT/EP2004/010639 is clearly directed towards altering the load on an electrical network in order to suit the prevailing conditions on the electrical network. This is somewhat different to the concept of the present invention which is to locally control the importation or exportation of electrical energy to/from the grid depending on prevailing local conditions on the electricity supply grid which are measured by local measurements devices adjacent the user facility.

The present invention is also advantageous over the system disclosed in U.S. Pat. No. 3,906,242 as the present invention does not require the use of a centralised controller unit having complicated communications protocols and networks.

A further advantage of the present invention is that the electrical power generation of the grid connected on site generator is also taken into account by the controller to produce a more effective operational determination based on the amount of electricity generated by the grid connected on site generator which forms part of the user facility.

In a further embodiment, the controller also receives electrical load readings from the user facility. In yet a further embodiment, a schedule of electrical load requirements by the user facility can be built up over a period of time so that future electrical power requirements and demands by the user facility can be estimated and accounted for in planning how the management of the consumption and distribution of electricity within the user facility is practised and implemented by the controller.

The electrical load readings are used to determine the overall user facility load requirement based on the accumulation of the electrical load readings from the user facility and the load requirements by any electrical energy storage units in the user facility.

In a further embodiment, the step of modifying the flow of electricity comprises importing electricity from the electricity supply grid if the electricity supply grid is oversupplied, or, exporting electricity to the electricity supply grid if the electricity supply grid is undersupplied.

In a further embodiment, electricity imported from the electricity supply grid is feed into an energy storage unit located in the user facility.

In a further embodiment, the step of importing electricity from the electricity supply grid and feeding the electricity into an energy storage unit located in the user facility is carried out during off-peak tariff periods. This may be financially advantageous to the owner or occupant of the user facility as relatively cheap electricity may be imported from the grid and stored for use by the user facility during peak tariff periods. In this manner, appliances within the user facility can be powered during peak tariff periods whilst only off-peak tariffs will be payable.

In a further embodiment, electricity exported to the electricity supply grid is retrieved from an electrical energy storage unit located in the user facility.

In a further embodiment, the step of exporting electricity to the electricity supply grid is carried out during peak tariff periods. In this manner, an owner of a user facility may profit from the electricity supply grid network operators by importing electricity from the grid during off-peak tariff periods and export electricity back onto the grid during peak tariff periods to result in a net financial gain.

In a further embodiment, electricity exported to the electricity supply grid is provided by the grid connected on site generator. The use of a grid connected on site generator is seen as a crucial aspect to the present invention in order to allow the most efficient management of the consumption and distribution of electricity within the user terminal by the controller of the present invention.

In a further embodiment, the locally measured waveform conditions comprise a voltage level of an electrical power signal on the electricity supply grid.

In a further embodiment, the locally measured waveform conditions comprise a current level of an electrical power signal on the electricity supply grid.

In a further embodiment, the locally measured waveform conditions comprise a frequency reading of an electrical power signal on the electricity supply grid.

In a further embodiment, the locally measured waveform conditions comprise a vector shift of an electrical power signal on the electricity supply grid.

In a further embodiment, the importation and/or exportation of electricity from and to the electricity supply grid is staggered between a plurality of neighbouring user facilities.

It is important to stagger the importation and/or exportation of electricity from and to the electricity supply grid because mass importation and exportation by a number of neighbouring user facilities contemporaneously may cause unwonted effects on the electricity supply grid, and in severe instances may cause a network failure resulting in a greyout or blackout.

In a further embodiment, the staggering of the importation and exportation is carried out based on a priority ranking for each of the plurality of neighbouring user facilities.

In a further embodiment, the priority ranking for each of the plurality of neighbouring user facilities is pre-determined.

In a further embodiment, the priority ranking for each of the plurality of neighbouring user facilities is variable depending on historical importation and/or exportation volumes by the relative neighbouring user facilities.

In a further embodiment, the exportation of electricity to the electricity supply grid is dampened such that the electricity exported to the grid is within predefined acceptable voltage, current and/or frequency ranges.

In a further embodiment, the step of modifying the flow of electricity in the user facility comprises supplying energy to a thermal storage unit. The use of a thermal storage unit is seen as particularly advantageous as the majority of households and commercial properties already have hot water cylinders which may be used as a thermal storage unit.

In a further embodiment, the step of modifying the flow of electricity in the user facility comprises supplying energy to a thermal dump unit.

In a further embodiment, the step of supplying energy to a thermal dump unit is carried out when excess electricity generated by the on site generator cannot be exported to the electricity supply grid.

In a further embodiment, the step of modifying the flow of electricity in the user facility comprises altering the overall electrical load of the user facility by altering the consumption of electricity by an electricity storage unit.

In a further embodiment, a remotely operated controller may override the controller to modify the flow of electricity within the user facility.

The present invention further relates to an electricity management system located in a user facility, wherein the user facility receives electricity from an electricity supply grid and a grid connected on site generator; the electricity management system comprising a on site controller and an electricity supply grid waveform conditions measurement device.

In a further embodiment, the electricity management system further comprises an electrical energy storage unit.

In further embodiments, the electrical energy storage unit is a wet thermal storage unit, or a dry thermal storage unit or a battery bank.

In a further embodiment, the electrical energy storage unit is a pump system. The pump system may advantageously pump a fluid to a height above a turbine and upon receipt of instruction from an associated pump system controller, allow the fluid to fall under gravity through the turbine to generate electricity.

In a further embodiment, the electricity supply grid conditions measurement device assesses a voltage level of an electrical power signal on the electricity supply grid.

In a further embodiment, the electricity supply grid conditions measurement device assesses a current level of an electrical power signal on the electricity supply grid.

In a further embodiment, the electricity supply grid conditions measurement device assesses a frequency reading of an electrical power signal on the electricity supply grid.

In a further embodiment, the electricity supply grid conditions measurement device assesses a vector shift of an electrical power signal on the electricity supply grid.

In a further embodiment, the on site controller governs the importation and exportation of electricity from and to the electricity supply grid in accordance with the electricity supply grid conditions and the amount of electrical power generated by the grid connected on site generator.

In a further embodiment, the on site controller governs the importation and exportation of electricity from and to the electricity supply grid in accordance with a staggered pattern with respect to neighbouring user facilities.

In a further embodiment, the staggering of the importation and exportation is carried out based on a priority ranking for each of the plurality of neighbouring user facilities.

In a further embodiment, the priority ranking for each of the plurality of neighbouring user facilities is pre-determined.

In a further embodiment, the priority ranking for each of the plurality of neighbouring user facilities is variable depending on historical importation and/or exportation volumes.

In a further embodiment, the electricity management system further comprises a thermal dump unit.

In a further embodiment, the thermal dump unit only receives electricity when excess electrical power is generated by a on site generator and that excess electrical power cannot be exported to the electricity supply grid due to prevailing electricity supply grid waveform conditions measured by the electricity supply grid waveform conditions measurement device.

In a further embodiment, the controller receives electrical power readings from the on site generator and electrical load readings from the user facility.

In a further embodiment, a remotely operated controller may override the on site controller to modify the flow of electricity within the user facility.

In a further embodiment, the controller or on site controller may form part of a smart meter.

The present invention is directed to a method of managing the electrical power in a terminal user facility, wherein the terminal user facility is connected to an electricity supply grid; the method comprising the steps of measuring waveform conditions on a portion of the electricity supply grid substantially adjacent the terminal user facility to obtain locally measured waveform conditions; communicating the locally measured waveform conditions to a locally based controller in the terminal user facility; determining, at least on the basis of the locally measured waveform conditions, whether the electricity supply grid is oversupplied or undersupplied with electrical power; and, modifying the flow of electrical power within the terminal user facility based on commands from the locally based controller.

The advantage of measuring waveform conditions on a portion of the electricity supply grid that is substantially adjacent the terminal user facility is that no communication packets need to be sent from a central controller in the electricity supply grid to a smart meter in the terminal user facility. Instead, the measurements are taken from the electricity supply grid substantially adjacent the terminal user facility and these measurements are supplied to a locally-based controller which has the processing power and ability to control the import or export of electrical power from and to the electricity supply grid. An electricity supply grid conditions measurement instrument is located adjacent a plurality of terminal user facilities and each electricity supply grid conditions measurement instrument supplies electricity waveform condition measurements to the locally-based controller for that terminal user facility. The measurements are not taken at a transformer station, sub-station, switching compound or measurement point as before.

Thus, far less complicated communications protocols and networking is required. This is a greatly simplified system in comparison with the systems known from the prior art as no complex communications protocols are needed and/or no expensive hardware need be arranged over the electricity supply grid. Moreover, control of the electricity supply grid may be managed locally and the responsiveness of the control commands will be greatly increased due to the locally based nature of the system.

In a further embodiment, the controller forms part of a smart meter which also receives electrical power readings from a on site generator which forms part of the terminal user facility and electrical load readings from the terminal user facility.

In a further embodiment, the step of modifying usage of electrical power comprises importing electrical power from the electricity supply grid if the electricity supply grid is oversupplied, or, exporting electrical power to the electricity supply grid if the electricity supply grid is undersupplied.

In a further embodiment, electrical power imported from the electricity supply grid is feed into an energy storage unit located in the terminal user facility.

In a further embodiment, electrical power exported to the electricity supply grid is retrieved from an energy storage unit located in the terminal user facility.

In a further embodiment, the locally measured waveform conditions comprise a voltage level of an electrical power signal on the electricity supply grid.

In a further embodiment, the locally measured waveform conditions comprise a current level of an electrical power signal on the electricity supply grid.

In a further embodiment, the locally measured waveform conditions comprise a frequency reading of an electrical power signal on the electricity supply grid.

In a further embodiment, the locally measured waveform conditions comprise a vector shift of an electrical power signal on the electricity supply grid.

In a further embodiment, the importation and/or exportation of electrical power from and to the electricity supply grid is staggered between a plurality of neighbouring terminal user facilities. In a further embodiment, the staggering of the importation and exportation is carried out based on a priority ranking for each of the plurality of neighbouring terminal user facilities.

In a further embodiment, the priority ranking for each of the plurality of neighbouring terminal user facilities is pre-determined.

In a further embodiment, the priority ranking for each of the plurality of neighbouring terminal user facilities is variable depending on historical importation and/or exportation volumes.

In a further embodiment, the step of modifying usage of electrical power in the terminal user facility comprises supplying energy to a thermal storage unit.

In a further embodiment, the step of modifying usage of electrical power in the terminal user facility comprises supplying energy to a thermal dump unit.

In a further embodiment, the step of supplying energy to a thermal dump unit is carried out when excess electrical power generated by a on site generator cannot be exported to the electricity supply grid.

In a further embodiment, the step of modifying usage of electrical power in the terminal user facility comprises altering the electrical load of the terminal user facility.

In a further embodiment, a remotely operated controller may override the controller to modify the flow of electrical power within the terminal user facility.

The invention is further directed towards an electricity management system located in a terminal user facility, wherein the terminal user facility receives electrical power from an electricity supply grid; the electricity management system comprising a locally-based controller and an electricity supply grid waveform conditions measurement device.

Similarly to above, the advantage of providing an electricity management system located in a terminal user facility is that no communication packets need to be sent from a central controller in the electricity supply grid to the local control unit in the terminal user facility. Thus, a greatly simplified system is provided and no complex communications protocols and/or hardware need to be arranged over the electricity supply grid.

In a further embodiment, the electricity management system further comprises an energy storage unit.

In a further embodiment, the energy storage unit is one of a wet thermal storage unit, a dry thermal storage unit, and a battery bank.

In a further embodiment, the electricity supply grid conditions measurement device assesses a voltage level of an electrical power signal on the electricity supply grid.

In a further embodiment, the electricity supply grid conditions measurement device assesses a current level of an electrical power signal on the electricity supply grid.

In a further embodiment, the electricity supply grid conditions measurement device assesses a frequency reading of an electrical power signal on the electricity supply grid.

In a further embodiment, the electricity supply grid conditions measurement device assesses a vector shift of an electrical power signal on the electricity supply grid.

In a further embodiment, the locally-based controller governs the importation and exportation of electrical power from and to the electricity supply grid in accordance with a staggered pattern with respect to neighbouring terminal user facilities.

In a further embodiment, the staggering of the importation and exportation is carried out based on a priority ranking for each of the plurality of neighbouring terminal user facilities.

In a further embodiment, the priority ranking for each of the plurality of neighbouring terminal user facilities is pre-determined.

In a further embodiment, the priority ranking for each of the plurality of neighbouring terminal user facilities is variable depending on historical importation and/or exportation volumes.

In a further embodiment, the electricity management system further comprises a thermal storage unit.

In a further embodiment, the electricity management system further comprises a thermal dump unit.

In a further embodiment, the thermal dump unit only receives electrical power when excess electrical power is generated by a on site generator and that excess electrical power cannot be exported to the electricity supply grid due to prevailing electricity supply grid waveform conditions measured by the electricity supply grid waveform conditions measurement device.

In a further embodiment, the electricity management system comprises a smart meter to receive electrical power readings from a on site generator which forms part of the terminal user facility and electrical load readings from the terminal user facility.

In a further embodiment, a remotely operated controller may override the locally-based controller to modify the flow of electrical power within the terminal user facility.

### DETAILED DESCRIPTION OF EMBODIMENTS

The invention will be more clearly understood from the following description of some embodiments thereof, given by way of example only with reference to the accompanying drawing, in which:

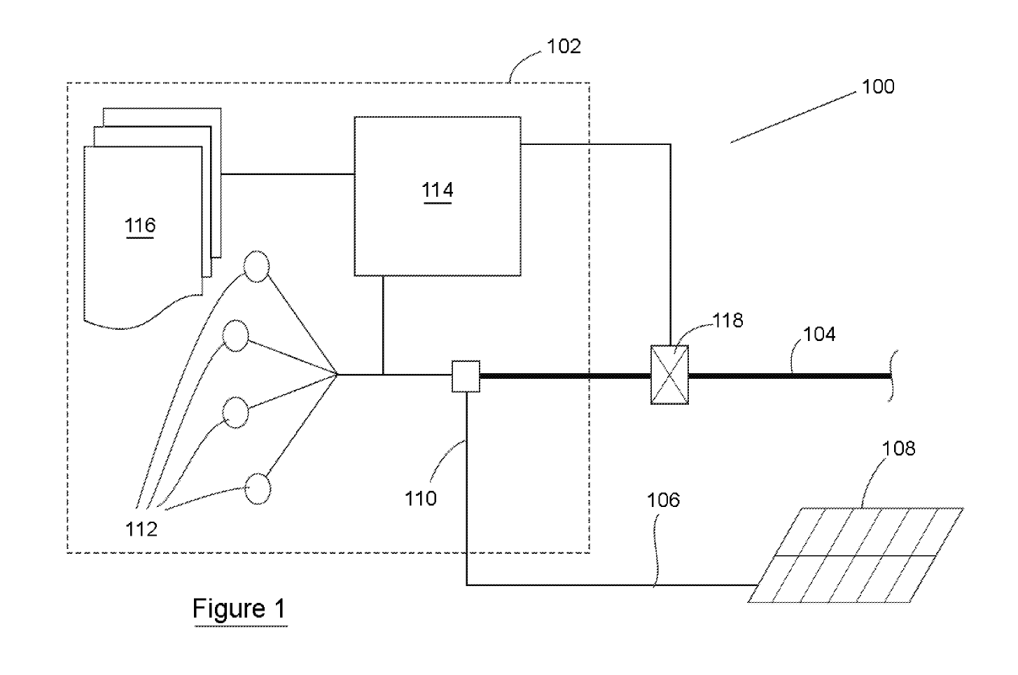

FIG. 1 is a diagrammatic representation of an electricity management system according to the present invention;

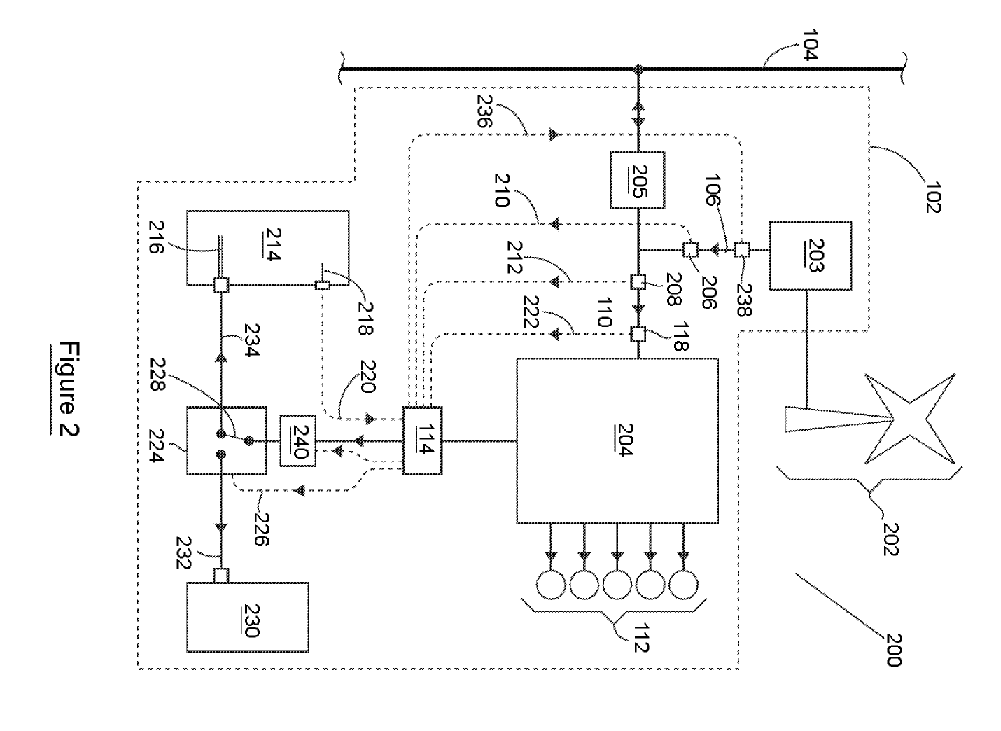

FIG. 2 is a diagrammatic representation of an electricity management system according to a further embodiment of the present invention;

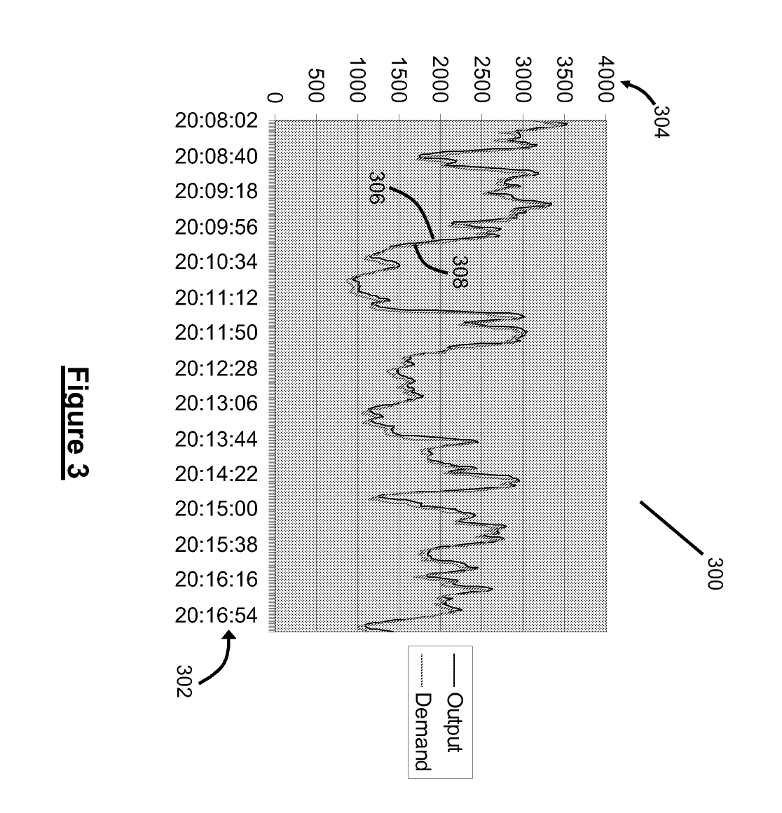

FIG. 3 is a graph showing the controlled alteration of an overall load of a user terminal in response to the variation in the supply of electricity to the user terminal; and,

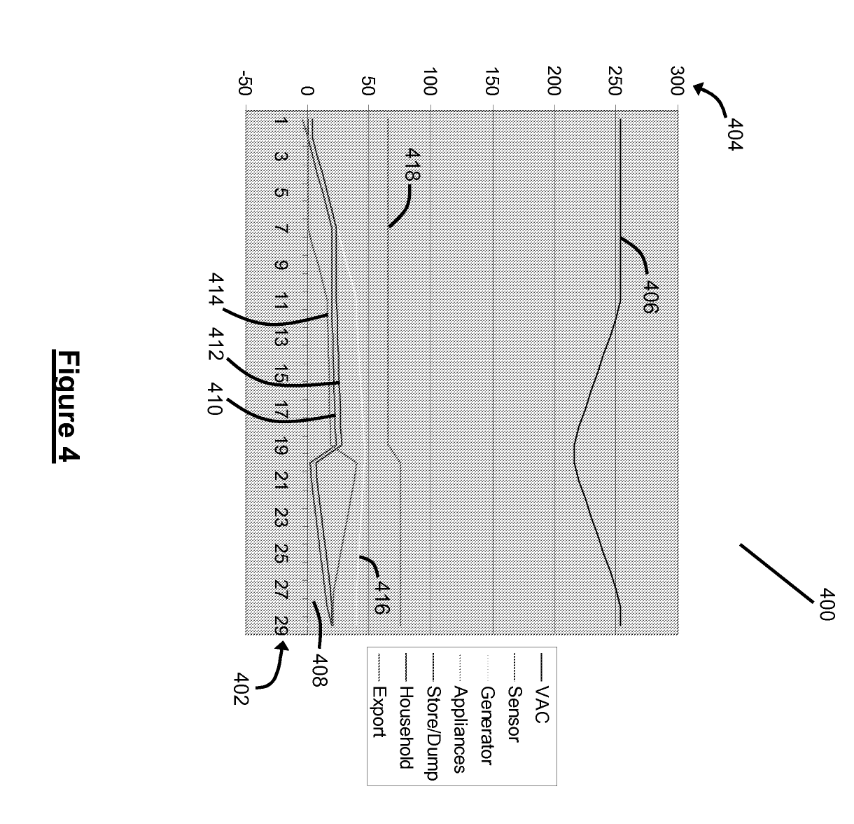

FIG. 4 is a graph showing a number of measurements within the user terminal during the operation of the present invention.

Referring to FIG. 1, there is provided an electricity management system indicated generally by the reference numeral 100. The electricity management system 100 is housed in a terminal user facility 102 such as a domestic residence, a commercial building or a public building (not shown).

An electrical power input is provided to the terminal user facility 102 from an electricity supply grid 104. Locally generated electrical power 106 is also provided to the terminal user facility 102. In this embodiment, the locally generated electrical power 106 is generated from an on site generator in the form of a solar panel 108. It will be understood that the locally generated electrical power 106 may be generated from any number of known on site generators such as wind turbines, biomass-based electrical energy generators and the like. The electrical power from the electricity supply grid 104 and the locally generated electrical power 106 are combined to provide a combined electrical power input 110 to the terminal user facility 102.

The combined electrical power input 110 is transmitted to a plurality of sub-circuits and electrically operated devices 112 as would be typically found within the terminal user facility 102. An on site controller 114 is located in the terminal user facility 102. An energy storage device 116 is also located in the terminal user facility 102. The energy storage device 116 may be a wet thermal storage unit, a dry thermal storage unit or an electrical storage units such as a bank of batteries.

The on site controller 114, which may advantageously form part of a smart meter, governs and manages the flow of electrical power within the terminal user facility 102. Energy from the combined electrical power input 110 may be routed to the energy storage device 116 for retrieval at a later point in time.

An electricity supply grid waveform conditions measurement device 118 is located adjacent the terminal user facility 102 and measures the waveform conditions of the electrical energy signals transmitted over the electricity supply grid 104. The measured electricity supply grid waveform conditions may comprise the voltage level, current level, wave frequency, waveform, variances of these signals from a specific predetermined amount, the rate of change of any of these signal characteristics and/or any other measurable characteristics which will indicate if a grid is overloaded or underloaded with electricity. These measured electricity supply grid waveform conditions are sent over a dedicated line along a relatively short distance to the on site controller 114 in the terminal user facility 102. The on site controller 114 analyses the measured electricity supply grid waveform conditions and determines whether the electricity supply grid 104 is oversupplied with electrical power or is undersupplied with electrical power.

Based on this information, the on site controller 114 can arrange for the energy storage device 116 to export electrical power to the electricity supply grid 104 if the electricity supply grid 104 is undersupplied, or, the on site controller 114 can arrange for the energy storage device 116 to import electrical power from the electricity supply grid 104 if the electricity supply grid 104 is oversupplied.

There may be problems if a number of neighbouring terminal user facilities 102 all determine that the same portion of the electricity supply grid 104 adjacent them is undersupplied and attempt to export electrical energy at the same time onto the electricity supply grid 104 as this will cause an overload of electrical power on the electricity supply grid 104.

Thus, the on site controller 114 of neighbouring terminal user facilities 102 may be programmed to stagger the exportation of electrical energy onto the electricity supply grid 104. The staggering of the electricity from the neighbouring terminal user facilities 102 may be based on a pre-determined sequencing or a variable sequencing which is sent to the neighbouring terminal user facilities 102 from a network control centre (not shown). Such a variable sequencing may be decided upon on the basis of historical data relating to the importation and/or exportation of electrical energy to the electricity supply grid 104.

In further embodiments (not shown), the importation or exportation of electrical energy may be delayed by control mechanisms in the on site controller 114 in order to allow the electricity supply grid waveform conditions measurement device 118 to react to a previous change on the grid. Moreover, the amount of electrical energy which is imported or exported to/from the grid may be dampened in order to prevent overshooting and/or oscillations from occurring on the grid. A combination of both damping and delaying the importation and/or exportation of electrical energy to/from the grid is generally intended to stabilise the electricity supply grid as much as possible.

It is further foreseen that a terminal user facility 102 may comprise a smart meter (not shown) to control the consumption of electrical energy in the facility 102. The smart meter may form part of the on site controller 114 or may be a separate device. The measured conditions on the electricity supply grid 104 will act as further control inputs to the smart meter in order to allow the smart meter to intelligently control the consumption of electrical energy in the terminal user facility 102. Even if the terminal user facility 102 does not have an electrical energy storage medium, it will still be beneficial for a user to measurement the conditions on the electricity supply grid 104 so as to control the consumption of electrical energy by devices 112 within the facility 102 can be modified and adjusted in reaction to the measured conditions.

For example, heating elements for a swimming pool may be switched on during the night time as cheaper off-peak tariffs may apply. However, if the electricity supply grid 104 is undersupplied, then the controller may take the decision not to import electrical energy from the electricity supply grid 104 at that time.

Furthermore, electrical energy storage devices 112 are not necessarily required and it is foreseen to use other energy storage devices such as swimming pools, water storage cylinders, storage heaters, storage coolers such as refrigerators and freezers and /or underfloor heating. Energy may be stored in these devices and exported to the electricity supply grid 104 if the grid is overloaded, or, the electrical energy stored in these devices may be used by electrically operated devices within the terminal user facility 102.

The on site controller 114 is arranged to receive the measured conditions of the electricity supply grid 104. These measured conditions may be then used in a number of ways to control the consumption of electrical energy within the terminal user facility 102, to control the importation and/or exportation of electrical energy to the electricity supply grid 104 and to control the storage of electrical energy in electrical energy storage device 116 or in the other types of energy storage devices.

Referring to FIG. 2, wherein like parts previously described have been assigned the same reference numerals, there is provided an electricity management system indicated generally by the reference numeral 200. The electricity management system 200 is housed in a terminal user facility 202 such as a domestic residence, a commercial building or a public building (not shown).

Electrical power is connected to the terminal user facility 102 from the electricity supply grid 104. An electricity supply meter 205 is connected to the electricity supply grid 104.

Locally generated electrical power 106 is also provided to the terminal user facility 102. In this embodiment, the locally generated electrical power 106 is generated from a on site generator in the form of a wind turbine 202. An inverter 203 converts the electrical power generated by the wind turbine 202 into AC electrical power which is in-phase with the AC electrical power from the electricity supply grid 104.

The electrical power from the electricity supply grid 104 and the locally generated electrical power 106 are combined to provide combined electrical power 110 which is supplied to a distribution board 204 in the terminal user facility 102.

The combined electrical power 110 is transmitted to a plurality of sub-circuits and electrically operated devices 112 as would be typically found within a terminal user facility 102.

An on site controller in the form of a smart meter 114 is located in the terminal user facility 102. An energy storage device, in this embodiment a wet thermal energy storage unit 214, is also located in the terminal user facility 102. The energy storage device may alternatively be a dry thermal storage unit or an electrical storage unit such as a battery bank.

The locally based smart meter 114 governs and manages the flow of electrical power within the terminal user facility 102.

A first current measurement device 206 measures the electrical power generated by the wind turbine 202. The current measurement device 206 is preferably a non-directional current transformer. A second current measurement device 208 measures the combined electrical power 110 entering the distribution board 204. As before, the second current measurement device 208 is also preferably a non-directional current transformer. Readings from the first and second current measurement devices 206, 208 are provided to the smart meter 114 via data links 210, 212 respectively. The smart meter 114 may use the readings from the first and second current measurement devices 206, 208 to determine if the locally generated electrical power 106 is sufficient to meet the electrical load requirements of the sub-circuits 112 in the terminal user facility 102 or if electrical power is required from the electricity supply grid 104.

In a further embodiment, a directional current transformer may be arranged adjacent the electricity supply grid 104 which works in conjunction with one of the first or second current measurement devices 206, 208 to obtain the same information as discussed above. However, due to the cheaper costs associated with non-directional current transformers, the former option is preferable.

Dependent on load requirements in the terminal user facility 102, excess electrical power generated by the wind turbine 202 may be routed by the smart meter 114 into the thermal energy storage unit 214. The thermal energy storage unit 214 comprises a resistive heating element 216 and a temperature sensor 218. The temperature sensor 218 sends temperature data readings back to the locally-based smart meter 114 via a data communication link 220. The readings may be used to ensure that the temperature of the wet thermal storage unit 214 remains at optimal and regulated temperature ranges to ensure that bacteria such as legionella bacteria do not form.

An electricity supply grid waveform conditions measurement device 118 is located substantially adjacent the electricity supply grid 104 and measures the waveform conditions of the electrical energy signals transmitted over the electricity supply grid 104. The measured electricity supply grid waveform conditions may comprise the voltage level, current level, wave frequency, waveform, variances of these signals from a specific pre-determined amount, the rate of change of any of these signal characteristics and/or any other measurable characteristics which will indicate if a grid is overloaded or underloaded with electricity. These measured electricity supply grid waveform conditions are sent along a dedicated communications link 222 over a relatively short distance to the smart meter 114.

The smart meter 114 analyses the measured electricity supply grid waveform conditions, inter alia, with readings from the first and second current measurement devices 206, 208 to determine whether the electricity supply grid 104 is oversupplied with electrical power or is undersupplied with electrical power; the amount of electrical power currently required by the terminal user facility 102; and, the amount of electrical power currently generated by the wind turbine 202 in the terminal user facility 102.

Based on this information, the smart meter 114 can arrange for the electricity management system 200 to export electrical power to the electricity supply grid 104 directly from the locally generated electrical power 106 if the electricity supply grid 104 is oversupplied.

Moreover, the smart meter 114 can arrange for the electricity management system 200 to only supply electrical power to the terminal user facility 102 from the thermal energy storage unit 214 or from the locally generated electrical power 106 if the electricity supply grid 104 is oversupplied.

Alternatively, the smart meter 114 can arrange for electrical power to be imported from the electricity supply grid 104 if the electricity supply grid 104 is oversupplied. The imported energy may be stored in the wet thermal energy storage unit 214 for later use.

Furthermore, the electrical load characteristics of the terminal user facility 102 may be altered to intentionally create a demand for electrical power from the electricity supply grid 104 when the electricity supply grid 104 is oversupplied.

A relay switch 224 is connected between the electrical power supply from the distribution board 204 and the wet thermal energy storage unit 214. A current control unit 240, typically in the form of a thyristor, is connected intermediate the smart meter 114 and the relay switch 224 to control and adapt the current flow.

If the temperature sensor 218 in the wet thermal energy storage unit 214 indicates that the wet thermal storage unit 214 is operating at a maximum capacity, then the smart meter 114 may send a command signal along communication path 226 to the relay switch 224. The relay switch 224 may in turn operate the switch 228 so as to divert electrical power to the thermal dump 230 along connection 232. Under normal operation, electrical power would be diverted along connection 234 to the resistive heating element 216 in the wet thermal storage unit 214.

In a further embodiment, if the wind turbine 202 is providing an excess amount of electrical power which cannot be handled, or is creating a dangerously high spike in electrical power which could damage sub-circuits 112 in the terminal user facility 102 or damage the electricity supply grid 104, then the smart meter 114 may send a command signal over communication link 236 to an isolator 238 which will isolate the locally generated electrical power 106 from the remainder of the electrical circuitry in the terminal user facility 102.

In a further embodiment, a remotely based controller with access to readings from the entire electricity supply grid may override commands in the smart meter 114 in order to ensure smooth and efficient operation of the electricity supply grid 104. For example, the remotely based controller may be aware that a number of generators are about to come online and therefore may reduce the amount of electrical power which is being currently exported to the electricity supply grid 114. In this manner, an overload scenario on the electricity supply grid 114 can be avoided.

Referring to FIG. 3, there is provided a graph indicated generally by the reference numeral 300. The graph 300 shows electrical power in Watts along the abscissa axis indicated by reference 302 and time that the measurement was taken in the 24-hour clock format along the ordinate axis indicated by reference numeral 304. The graph 300 shows the total demand 308, in terms of the load of a user terminal, and the total output 306, in terms of the accumulated electricity supply to the user terminal from the electricity supply grid and the grid connected on site generator. As can be seen from the graph 300 in FIG. 3, the controller/smart meter of the present invention can be used to adjust the overall load of a user terminal to follow the electricity supplied to the user terminal in a very controlled and close trailing manner. Therefore, by closely controlling the flow of electricity in the user terminal, the conditions of the electricity supply grid can be guarded against becoming overloaded or under loaded. However, in cases where the electricity supply grid has become overloaded or under loaded, it can be easily envisaged that the control of the load in the user terminal could be adjusted to intentionally deviate from the supply of electricity to the user terminal in order to cause an importation or exportation of electricity between the user terminal and the electricity supply grid. This intentional deviation from the controlled trailing of the electricity supplied to the user terminal may be implemented as a result of a reading of the current grid conditions on the electricity supply grid by measurements devices located on a section of the electricity supply grid which is adjacent the user terminal.

With reference to FIG. 4, there is provided a graph indicated generally by reference numeral 400. The graph 400 shows the operation of the present invention. Data from a household (not shown) having a constant appliance load 408 of 1 kW; a micro-generator output 416 varying from 0 to 10 kW; a system voltage 406 varying from 216.2 V to 253 V; with surplus power being directed either to a thermal energy storage unit (not shown) or thermal dump (not shown). The amount of power exported is kept to a minimum when surplus power is being stored. The amount of power dumped is kept to a minimum when surplus power is being dumped, and the amount of current exported is kept below the approved limits at all times.

It is assumed that the approved export limit varies with voltage from 20 Amps at 253 Volts to 23.4 Amps at 216.2 Volts.

The abscissa axis 402 shows time measured intervals of approximately one minute. The ordinate axis 404 is simply a numerical division.

The units of measurement on the ordinate axis 404 for system voltage 406 are RMS AC Voltage (VAC); for the thermal store measurement 418 are degrees centigrade (i.e. the Sensor); for the generator output current 416 (i.e. the Generator) are Amps. The load being diverted to the thermal store or dump 410 (i.e. Store/Dump) is also measured in Amps and the total household load 412 (i.e. Household) is also measured in Amps. The exported power 414 (i.e. Export) to the grid is measured and shown in Amps.

It will be understood that in a further embodiment of the present invention, a terminal user facility 102 may not incorporate a on site generator but may instead solely rely upon the thermal storage unit 214 to import electrical power from the electricity supply grid 104 when the electricity supply grid 104 is oversupplied, and subsequently use this stored thermal energy in the terminal user facility 102 when the electricity supply grid 104 is undersupplied.

Throughout the preceding specification, any reference to the term “smart meter” should be interpreted broadly to cover any type of controller unit comprising processing means and communication means and is not necessarily limited to a strict definition of a smart meter.

In the specification the terms “comprise, comprises, comprised and comprising” or any variation thereof and the terms “include, includes, included and including” or any variation thereof are considered to be totally interchangeable and they should all be afforded the widest possible interpretation.

The invention is not limited to the embodiments hereinbefore described which may be varied in both construction and detail within the scope of the appended claims.

1. A method of managing the consumption and distribution of electricity in a user facility, wherein the user facility is connected to an electricity supply grid and the user facility comprises a grid connected on site generator; the method comprising the steps of:
a. measuring waveform conditions on a portion of the electricity supply grid adjacent the user facility to obtain locally measured waveform conditions;
b. measuring electrical power readings from the on site generator;
c. communicating the locally measured waveform conditions and the electrical power readings to a controller in the user facility;
d. determining, at least on the basis of the locally measured waveform conditions, whether the electricity supply grid is oversupplied or undersupplied with electricity; and,
e. modifying the flow of the electricity within the user facility based on whether the electricity supply grid is oversupplied or undersupplied with electricity and/or the electrical power readings from the grid connected on site generator.

2. A method as claimed in claim 1, wherein,
the controller is a smart meter and the smart meter also receives electrical load readings from the user facility.

3. A method as claimed in claim 1, wherein,
the step of modifying the flow of electricity comprises importing electricity from the electricity supply grid if the electricity supply grid is oversupplied, or, exporting electricity to the electricity supply grid if the electricity supply grid is undersupplied.

4. A method as claimed in claim 3, wherein,
electricity imported from the electricity supply grid is feed into an energy storage unit located in the user facility.

5. A method as claimed in claim 4, wherein,
the step of importing electricity from the electricity supply grid and feeding the electricity into an energy storage unit located in the user facility is carried out during off-peak tariff periods.

6. A method as claimed in claim 3, wherein,
electricity exported to the electricity supply grid is retrieved from an electrical energy storage unit located in the user facility.

7. A method as claimed in claim 4, wherein,
the step of exporting electricity to the electricity supply grid is carried out during peak tariff periods.

8. A method as claimed in claim 3, wherein,
electricity exported to the electricity supply grid is provided by the grid connected on site generator.

9. A method as claimed in any preceding claim, wherein,
the locally measured waveform conditions comprise a voltage level of an electrical power signal on the electricity supply grid.

10. A method as claimed in any preceding claim, wherein,
the locally measured waveform conditions comprise a current level of an electrical power signal on the electricity supply grid.

11. A method as claimed in any preceding claim, wherein,
the locally measured waveform conditions comprise a frequency reading of an electrical power signal on the electricity supply grid.

12. A method as claimed in any preceding claim, wherein,
the locally measured waveform conditions comprise a vector shift of an electrical power signal on the electricity supply grid.

13. A method as claimed in claims 3 to 12, wherein,
the importation and/or exportation of electricity from and to the electricity supply grid is staggered between a plurality of neighbouring user facilities.

14. A method as claimed in claim 13, wherein,
the staggering of the importation and exportation is carried out based on a priority ranking for each of the plurality of neighbouring user facilities.

15. A method as claimed in claim 14, wherein,
the priority ranking for each of the plurality of neighbouring user facilities is pre-determined.

16. A method as claimed in claim 14, wherein,
the priority ranking for each of the plurality of neighbouring user facilities is variable depending on historical importation and/or exportation volumes by the relative neighbouring user facilities.

17. A method as claimed in claims 3 to 16, wherein,
the exportation of electricity to the electricity supply grid is dampened such that the electricity exported to the grid is within predefined acceptable voltage, current and/or frequency ranges.

18. A method as claimed in any preceding claim, wherein,
the step of modifying the flow of electricity in the user facility comprises supplying energy to a thermal storage unit.

19. A method as claimed in any preceding claim, wherein,
the step of modifying the flow of electricity in the user facility comprises supplying energy to a thermal dump unit.

20. A method as claimed in claim 19, wherein,
the step of supplying energy to a thermal dump unit is carried out when excess electricity generated by the on site generator cannot be exported to the electricity supply grid.

21. A method as claimed in any preceding claim, wherein,
the step of modifying the flow of electricity in the user facility comprises altering the overall electrical load of the user facility by altering the consumption of electricity by an electricity storage unit.

22. A method as claimed in any preceding claim, wherein,
a remotely operated controller may override the controller to modify the flow of electricity within the user facility.

23. An electricity management system located in a user facility, wherein the user
facility receives electricity from an electricity supply grid and a grid connected on site generator;
the electricity management system comprising a on site controller and an electricity supply grid waveform conditions measurement device.

24. An electricity management system as claimed in claim 23, wherein,
the electricity management system further comprises an electrical energy storage unit.

25. An electricity management system as claimed in claim 24, wherein,
the electrical energy storage unit is a wet thermal storage unit.

26. An electricity management system as claimed in claim 24, wherein,
the electrical energy storage unit is a dry thermal storage unit.

27. An electricity management system as claimed in claim 24, wherein,
the electrical energy storage unit is a battery bank.

28. An electricity management system as claimed in claim 24, wherein,
the electrical energy storage unit is a pump system.

29. An electricity management system as claimed in any of claims 23 to 28, wherein,
the electricity supply grid conditions measurement device assesses a voltage level of an electrical power signal on the electricity supply grid.

30. An electricity management system as claimed in any of claims 23 to 29, wherein,
the electricity supply grid conditions measurement device assesses a current level of an electrical power signal on the electricity supply grid.

31. An electricity management system as claimed in any of claims 23 to 30, wherein,
the electricity supply grid conditions measurement device assesses a frequency reading of an electrical power signal on the electricity supply grid.

32. An electricity management system as claimed in any of claims 23 to 31, wherein,
the electricity supply grid conditions measurement device assesses a vector shift of an electrical power signal on the electricity supply grid.

33. An electricity management system as claimed in any of claims 23 to 32, wherein,
the on site controller governs the importation and exportation of electricity from and to the electricity supply grid in accordance with the electricity supply grid conditions and the amount of electrical power generated by the grid connected on site generator.

34. An electricity management system as claimed in any of claims 23 to 33, wherein,
the on site controller governs the importation and exportation of electricity from and to the electricity supply grid in accordance with a staggered pattern with respect to neighbouring user facilities.

35. An electricity management system as claimed in claim 34, wherein,
the staggering of the importation and exportation is carried out based on a priority ranking for each of the plurality of neighbouring user facilities.

36. An electricity management system as claimed in claim 35, wherein,
the priority ranking for each of the plurality of neighbouring user facilities is pre-determined.

37. An electricity management system as claimed in claim 35, wherein,
the priority ranking for each of the plurality of neighbouring user facilities is variable depending on historical importation and/or exportation volumes.

38. An electricity management system as claimed in any of claims 23 to 37, wherein,
the electricity management system further comprises a thermal dump unit.

39. An electricity management system as claimed in claim 38, wherein,
the thermal dump unit only receives electricity when excess electrical power is generated by a on site generator and that excess electrical power cannot be exported to the electricity supply grid due to prevailing electricity supply grid waveform conditions measured by the electricity supply grid waveform conditions measurement device.

40. An electricity management system as claimed in any of claims 23 to 39, wherein,
the controller receives electrical power readings from the on site generator and electrical load readings from the user facility.

41. An electricity management system as claimed in any of claims 23 to 40, wherein,
a remotely operated controller may override the on site controller to modify the flow of electricity within the user facility.

42. An electricity management system as claimed in any of claims 23 to 41, wherein,
the on site controller forms part of a smart meter.
